(19) United States
(12) Patent Application Publication
(10) Pub. No.: US 2026/0338942 A1
(43) Pub. Date: Oct. 29, 2026

(54) MODULE TYPE SENSOR DEVICE FOR A VEHICLE

(71) Applicants: HYUNDAI MOTOR COMPANY, Seoul (KR); KIA CORPORATION, Seoul (KR)

(72) Inventors: Hong Heui Lee, Hwaseong-si (KR); Jin Young Yoon, Hwaseong-si (KR); Dong Ha Kim, Hwaseong-si (KR)

(73) Assignees: HYUNDAI MOTOR COMPANY, Seoul (KR); KIA CORPORATION, Seoul (KR)

(21) Appl. No.: 19/318,968

(22) Filed: Sep. 4, 2025

(30) Foreign Application Priority Data
Apr. 25, 2025 (KR) 10-2025-0054197

(51) Int. Cl. G01S 13/86; G01S 7/02; G01S 7/481; G01S 13/931; G01S 17/931

(52) U.S. Cl. CPC G01S 13/867; G01S 7/027; G01S 7/4813; G01S 13/865; G01S 13/931; G01S 17/931; G01S 2013/9327

(57) ABSTRACT

A module type sensor device for a vehicle has a structure in which a camera, a RADAR sensor, and a LIDAR sensor for autonomous travelling of the vehicle are modularized into a single unit so as to be mounted at a desired location on a vehicle body. The device is capable of self-repairing using heating of a heat wire when the surface of a protector is damaged. Additionally, the device is capable of improving sensing accuracy through sensor leveling in which the sensing areas of the RADAR sensor and/or LIDAR sensor are automatically corrected in response to changes in behavior of the vehicle body.

### CROSS-REFERENCE TO RELATED APPLICATION

This application claims, under 35 U.S.C. § 119(a), the benefit of and priority to Korean Patent Application No. 10-2025-0054197, filed on Apr. 25, 2025, the entire contents of which are incorporated herein by reference.

### TECHNICAL FIELD

The present disclosure relates to a module type sensor device for a vehicle. More particularly, the present disclosure relates to a module type sensor device for a vehicle, wherein a plurality of sensors for autonomous travelling are modularized into a single unit and mounted at a desired location on a vehicle body.

### BACKGROUND

Sensors for autonomous travelling of a vehicle, for example, a camera, a radio detection and ranging (RADAR) sensor, a light imaging detection and ranging (LIDAR) sensor, and the like, are mounted at predetermined locations on the vehicle.

Overall control of the autonomous traveling or driving including controlling travel direction, acceleration, and deceleration of the vehicle may be performed based on a photograph signal of the camera and the detection signals of the RADAR sensor and LIDAR sensor.

In a case where changes in the vehicle body behavior, for example, changes in behavior of the vehicle body in a left or right direction due to the vehicle turning, changes in behavior of the vehicle body in the forward or rear direction due to sudden stopping or starting of the vehicle, and changes in behavior of the vehicle body in the upward or downward direction due to changes in the number of passengers and a weight of a load applied to the vehicle, occur when the RADAR sensor and LIDAR sensor sense an adjacent vehicle, obstacle, or the like the sensing range or area of the RADAR sensor and LIDAR sensor must be automatically corrected so as to increase the sensing accuracy of the RADAR sensor and LIDAR sensor.

However, because the RADAR sensor and LIDAR sensor are mounted at a predetermined location on the vehicle in a fixed state, there is a problem in that the sensing range or area of the RADAR sensor and LIDAR sensor cannot be corrected when the vehicle body behavior changes.

Moreover, because the camera, RADAR sensor, and LIDAR sensor are each mounted at different locations on the vehicle body, the mounting structures configured to mount the camera, RADAR sensor, and LIDAR sensor on the vehicle body should be separately manufactured, causing problems such as an increase in the number of components and an increase in manufacturing costs.

Furthermore, a protector, which is a type of protective cover, positioned in front of or exterior to (e.g., with respect to the vehicle body) the RADAR sensor and LIDAR sensor mounted on the vehicle body may get surface damage, for example, due to chipping or abrasion caused by foreign substances, such as, stones, gravel, and the like, impacting the protective cover during travelling or driving of the vehicle. The surface damage on the protector may result in malfunction of the RADAR sensor and/or LIDAR sensor or a decrease in sensing accuracy of the RADAR sensor and/or the LIDAR sensor.

The above information disclosed in this Background section is only provided to enhance understanding of the background of the present disclosure. Therefore, the Background section may contain information that does not form the related art that is already known to a person of ordinary skill in the art.

### SUMMARY

The present disclosure has been made in an effort to solve the above-described problems associated with the related art. Various aspects of the present disclosure are directed to providing a module type sensor device for a vehicle. The device has a structure in which a camera, a RADAR sensor, and a LIDAR sensor for autonomous travelling of the vehicle are modularized into a single unit so as to be mounted at a desired location on a vehicle body. The device is capable of self-repairing by heating of a heat wire when the surface of a protector is damaged. Additionally, the device is capable of improving sensing accuracy through sensor leveling in which a position of the sensing areas of the RADAR sensor and LIDAR sensor are automatically corrected in response to changes in vehicle body behavior.

According to one aspect, the present disclosure provides a module type sensor device for a vehicle, the device including: a protector mounted on a vehicle body; a camera configured to capture images in front of the vehicle mounted on an upper portion of the protector; a bracket mounted on a rear surface of the protector; at least two actuators mounted on the bracket; and at least two sensors, the at least two sensors coupled to respective ones of the at least two actuators and configured to tilt up and down or left and right by driving of respective ones of the at least two actuators.

In an embodiment, the actuator may include: a fixed case mounted on the bracket; a tilting case having a front surface portion coupled to a respective one of the at least two sensors and a rear surface portion tiltably brought into contact with the fixed case; a first motor and a second motor mounted within the fixed case in a predetermined arrangement; a first output gear and a second output gear, wherein the first output gear is connected to an output shaft of the first motor and the second output gear is connected to an output shaft of the second motor; a first sector gear and a second sector gear each having one end portion connected to the tilting case; and a first transmission gear and a second transmission gear mounted within the fixed case, wherein the first transmission gear is configured to transmit the rotational force of the first output gear to the first sector gear and the second transmission gear is configured to transmit the rotational force of the second output gear to the second sector gear.

In another embodiment, the first motor and the second motor may be arranged perpendicular to each other within the fixed case, and the first output gear and the second output gear may also be arranged perpendicular to each other.

In another embodiment, the first sector gear may have an arch shape curved along a horizontal axis.

In another embodiment, a first fastening protrusion may be formed on an upper end portion of the first sector gear and a first fastening hole may be formed in the tilting case, wherein the first fastening protrusion is inserted and fastened into the first fastening hole.

In another embodiment, the first transmission gear may include a first pinion meshing with the first output gear, a second pinion meshing with the first sector gear, and a first rotational shaft configured to coaxially connect the first pinion to the second pinion and being rotatably coupled within the fixed case.

In another embodiment, the second sector gear may have an arch shape curved along a vertical axis.

In another embodiment, a second fastening protrusion may be formed on an upper end portion of the second sector gear and a second fastening hole may be formed in the tilting case, wherein the second fastening protrusion is inserted and fastened into the second fastening hole.

In another embodiment, the second transmission gear may include a first pinion meshing with the second output gear, a second pinion meshing with the second sector gear, and a second rotational shaft configured to coaxially connect the first pinion to the second pinion and being rotatably coupled within the fixed case.

In another embodiment, first mounting wings may be formed on a circumferential portion of the fixed case and be mounted on a front surface portion of the bracket, and second mounting wings may be formed on a circumferential portion of the tilting case and be mounted on a rear surface portion of the respective sensor of the at least two sensors.

In another embodiment, one of the at least two sensors may be a radio detection and ranging (RADAR) sensor or a light imaging detection and ranging (LIDAR) sensor.

In another embodiment, the protector may include a base plate made of plastic material, a protective cover made of a polyurethane material, the protective cover attached to an outer surface of the base plate, and a heat wire attached to an inner surface of the base plate.

In another embodiment, the protective cover may be injection-molded with a polyurethane material having a hardness of 75 and a thickness in a range of 0.5-1.0 millimeters.

According to another aspect, a module type sensor device for a vehicle includes a protecter mounted on a vehicle body, a camera mounted on the protector, a bracket mounted on a rear surface of the protector, an actuator mounted on the bracket, and a sensor coupled to the actuator and configured to tilt up and down or left and right by driving of the actuator.

In one or some embodiments, the actuator may include a fixed case mounted on the bracket and a tilting case having a front surface portion coupled to the sensor and a rear surface portion movably brought into contact with the fixed case.

In one or some embodiments, the sensor may be a radio detection and ranging (RADAR) sensor or a light imaging detection and ranging (LIDAR) sensor.

According to yet another aspect a module type sensor device for a vehicle includes a panel mounted on a vehicle body, a camera mounted on the protector, a bracket mounted on a rear surface of the protector, a first actuator mounted on the bracket, a first sensor coupled to the first actuator and configured to tilt up and down or left and right by driving of the first actuator, a second actuator mounted on the bracket, and a second sensor coupled to the first actuator and configured to tilt up and down or left and right by driving of the second actuator.

In one or some embodiments, the first actuator and the second actuator each include a fixed case coupled to the bracket, and a tilting case movably coupled to the fixed case.

In one or some embodiments, the first sensor may be a radio detection and ranging (RADAR) sensor and the second sensor may be a light imaging detection and ranging (LIDAR) sensor.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like. The term “vehicle’ or ‘vehicular’ or other similar terms include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure are described in detail with reference to various embodiments thereof illustrated in the accompanying drawings. The accompanying drawings are given herein below by way of illustration only, and thus are not limitative of the present disclosure, and wherein:

FIG. 1A and FIG. 1B are perspective views illustrating a module type sensor device for a vehicle according to the present disclosure;

FIG. 2 is an exploded perspective view illustrating an actuator of a module type sensor device for a vehicle according to the present disclosure;

FIG. 3 is an assembled perspective view illustrating an actuator of a module type sensor device for a vehicle according to the present disclosure;

FIG. 4 is an exploded perspective view illustrating a protector of a module type sensor device for a vehicle according to the present disclosure;

FIG. 5 is a cross-sectional view illustrating a protector of a module type sensor device for a vehicle according to the present disclosure;

FIGS. 6-8 are front views each illustrating an example in which a module type sensor device for a vehicle according to the present disclosure is mounted on a vehicle;

FIG. 9 is a cross-sectional view taken along line A-A of FIG. 6;

FIG. 10 is a cross-sectional view taken along line B-B of FIG. 6;

FIG. 11 is a cross-sectional view taken along line C-C of FIG. 6; and

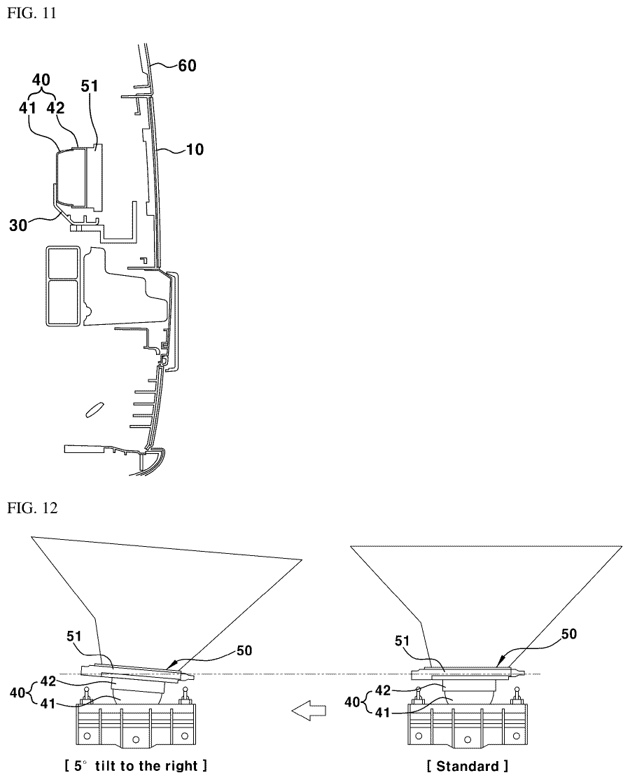

FIGS. 12 and 13 are plan views each illustrating an example of sensor leveling operation of a module type sensor device for a vehicle according to the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION

Descriptions of specific structures or functions presented in the embodiments of the present disclosure are merely provided by way of example for the purpose of explaining the embodiments according to the concept of the present disclosure The embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of various embodiments of the present disclosure.

It should be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes plural forms unless specified otherwise. The terms “comprises” and/or “comprising” used in this specification mean that the cited component, step, operation, and/or element does not exclude the presence or addition of one or more of other components, steps, operations, and/or elements. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

Hereinafter, various embodiments of the present disclosure are described in detail with reference to the attached drawings.

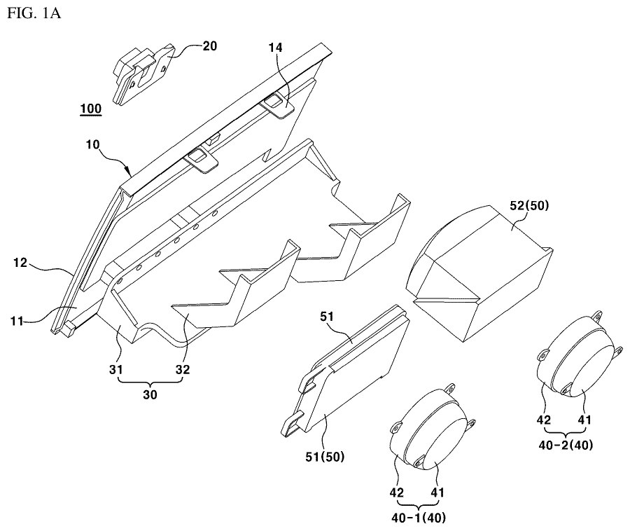

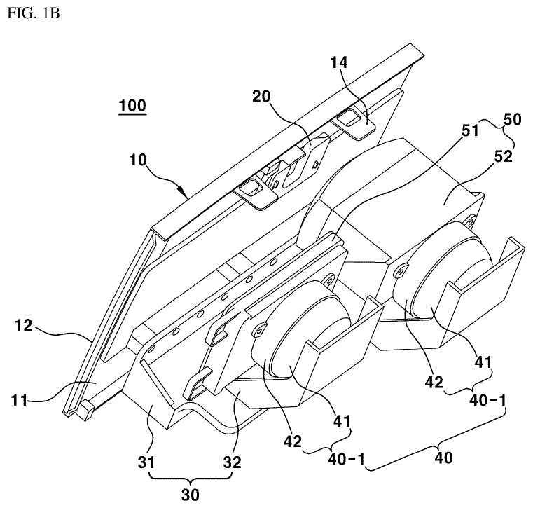

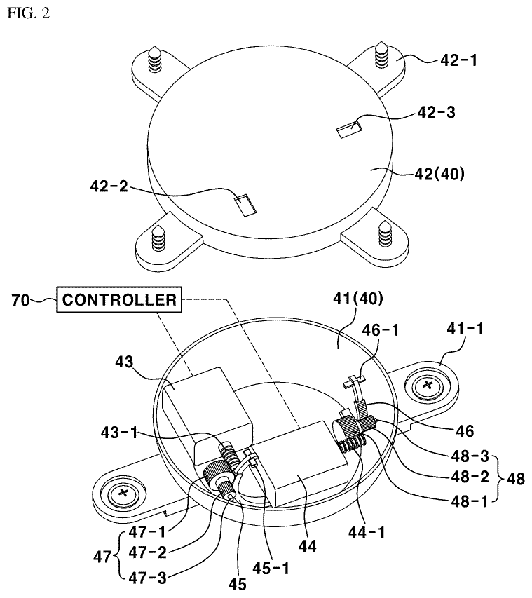

FIG. 1A and FIG. 1B are perspective views illustrating a module type sensor device for a vehicle according to the present disclosure. FIG. 2 and FIG. 3 illustrate an actuator of a module type sensor device for a vehicle according to the present disclosure.

A module type sensor device 100 for a vehicle according to the present disclosure may be provided as a modular component assembled into a single unit, wherein the modular component includes a panel or protector 10 mounted on a vehicle body to protect a sensor, a camera 20 capable of capturing forward shots or images mounted on an upper, outer, front, or exterior portion of the protector 10, a bracket 30 mounted on a rear surface of the protector 10, at least two actuators 40 mounted on the bracket 30, and a sensor 50 coupled to the actuator 40 and configured to tilt up and down or left and right by driving of the actuator 40. For example, the camera 20 may be configured to capture images of an area in front of the vehicle. The images may include objects in front of the vehicle.

The protector 10 is mounted on an external surface portion of the vehicle body (e.g., around a bumper) and serves to protect the sensor 50, the actuators 40, and the like.

To this end, a plurality of clips 14 configured to couple the protector 10 to the vehicle body may be integrated on or along an edge or periphery of the protector 10.

The camera 20 is configured to photograph the surroundings of the vehicle. The camera 20 is mounted in a mounting hole formed in the upper, outer, front, or exterior portion of the protector 10 and is arranged to photograph or capture images in a forward direction.

The bracket 30 includes a lower plate 31 configured to protect a lower portion of the sensor 50 by blocking foreign substances traveling in or entering (e.g., an undercarriage of the vehicle) from the ground while the vehicle is travelling, and an upper plate 32 configured to mount the actuator 40 on the bracket 30. The upper plate 32 may be arranged to extend upward from a rear end portion of the lower plate 31.

The sensor 50 coupled to the actuator 40 may be a radio detection and ranging (RADAR) sensor 51 configured to detect the distance and speed of an adjacent vehicle by emitting radio waves, or a light imaging detection and ranging (LIDAR) sensor 52 configured to detect the distance from an adjacent vehicle and obstacle by emitting laser light.

Accordingly, the actuator 40 may include a first actuator 40-1 configured to tilt the RADAR 51 up and down or left and right and a second actuator 40-2 configured to tilt the LIDAR 52 up and down or left and right., The first actuator 40-1 and the second actuator 40-2 may be identical in shape and structure.

The actuator 40 is a driving device capable of tilting the sensor 50 up and down or left and right at a predetermined angle, and includes a fixed case 41 mounted on the bracket 30 and a tilting case 42 coupled to the sensor 50.

The fixed case 41 has a structure which is open in a forward direction and is mounted on a front surface portion of the bracket 30.

To this end, first mounting wings 41-1 are integrated on opposite sides of a circumferential portion of the fixed case 41, respectively. The first mounting wings 41-1 are mounted on the front surface portion of the bracket 30 using a fastener (e.g., a screw, bolt, rivet, nail, or the like), so that the fixed case 41 may be arranged to be fixed on the front surface portion of the bracket 30.

The tilting case 42 has a structure which is open in a rearward direction and is coupled to a rear surface portion of the sensor 50.

To this end, second mounting wings 42-1 are integrated on positions in four directions on a circumferential portion of the tilting case 42, respectively. The second mounting wings 42-1 are mounted on the rear surface portion of the sensor 50 using a fastener (e.g., a screw, bolt, rivet, nail, or the like), so that the tilting case 42 may be arranged to be coupled to the rear surface portion of the sensor 50.

A first motor 43 and a second motor 44 are mounted within the fixed case 41 in a predetermined arrangement. The first motor 43 and the second motor 44 each have output shafts to which a first output gear 43-1 and a second output gear 44-1 are connected, respectively.

Here, the first motor 43 and the second motor 44 may be mounted in an arrangement so as to be disposed perpendicular to each other at an internal bottom of the fixed case 41, allowing the first output gear 43-1 of the first motor 43 and the second output gear 44-1 of the second motor 44 to be arranged perpendicular to each other.

Accordingly, the rotational force of the first output gear 43-1 driven by the first motor 43 may be used to tilt the tilting case 42 and the sensor 50 in a left-right direction, and the rotational force of the second output gear 44-1 driven by the second motor 44 may be used to tilt the tilting case 42 and the sensor 50 in an up-down direction. Rotational force of the first output gear 43-1 and the second output gear 44-1 may be used to tilt the tilting case 42 and the sensor about a pair of perpendicular axes.

One (e.g., a first) end portion of a first sector gear 45 and one (e.g., a first) end portion of a second sector gear 46 are connected to the tilting case 42, and another (e.g., second) end of the first sector gear 45 and another (e.g., second) end of the second sector gear 46 are arranged as free ends within the fixed case 41.

Here, a first fastening protrusion 45-1 is formed at the one (e.g., first) end portion of the first sector gear 45, a first fastening hole 42-2 is formed at a predetermined position in the tilting case 42, and the first fastening protrusion 45-1 is inserted to be locked into the first fastening hole 42-2, allowing the one (e.g., first) end portion of the first sector gear 45 to be connected and fixed to the tilting case 42.

Moreover, a second fastening protrusion 46-1 is formed at the one (e.g., first) end portion of the second sector gear 46, a second fastening hole 42-3 is formed at a predetermined position in the tilting case 42, and the second fastening protrusion 46-1 is inserted to be locked into the second fastening hole 42-3, allowing the one (e.g., first) end portion of the second sector gear 46 to be connected and fixed to the tilting case 42.

Here, the first sector gear 45 may have an arch shape (e.g., disposed along a horizontal axis) curved left or right so as to tilt the tilting case 42 and the sensor 50 to the left and right (e.g., relative to a horizontal axis) at a predetermined angle, and the second sector gear 46 may have an arch shape (e.g., disposed along a vertical axis) curved up or down so as to tilt the tilting case 42 and the sensor 50 up and down (e.g., relative to a vertical axis) at a predetermined angle.

A first transmission gear 47 configured to transmit the rotational force of the first output gear 43-1 of the first motor 43 to the first sector gear 45, and a second transmission gear 48 configured to transmit the rotational force of the second output gear 44-1 of the second motor 44 to the second sector gear 46 may be further mounted within the fixed case 41.

The first transmission gear 47 may include a first pinion 47-1 meshing with the first output gear 43-1, a second pinion 47-2 meshing with the first sector gear 45, and a rotational shaft 47-3 configured to coaxially connect the first pinion 47-1 to the second pinion 47-2 and being rotatably coupled or disposed at a predetermined position within the fixed case 41.

The second transmission gear 48 may include a first pinion 48-1 meshing with the second output gear 43-1, a second pinion 48-2 meshing with the second sector gear 46, and a rotational shaft 48-3 configured to coaxially connect the first pinion 48-1 to the second pinion 48-2 and being rotatably coupled or disposed at a predetermined position within the fixed case 41.

In this way, the module type sensor device 100 assembled into a single unit including the protector 10, the camera 20 capable of capturing forward shots or images mounted on the upper portion of the protector 10, the bracket 30 mounted on the rear surface of the protector 10, at least two actuators 40 mounted on the bracket 30, and at least one sensor 50 coupled to each of the at least two actuators 40 configured to tilt up and down or left and right by driving of the actuator 40, may be mounted at a desired location on various types of vehicles.

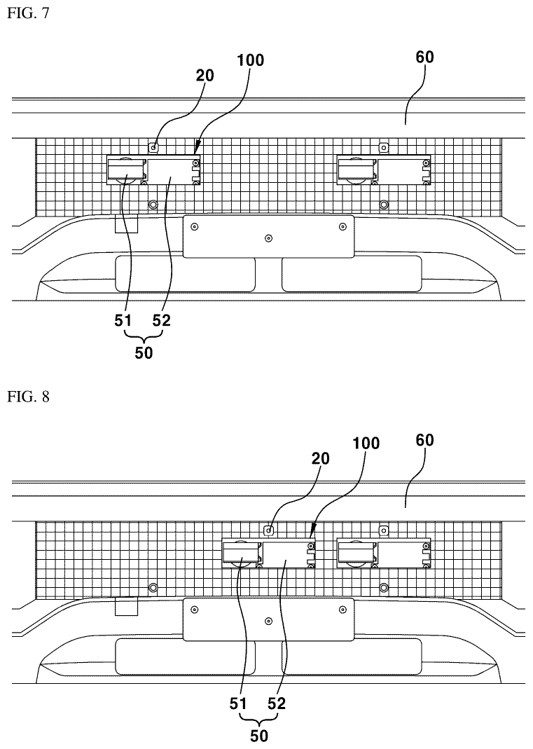

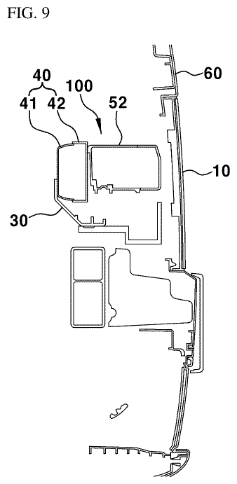

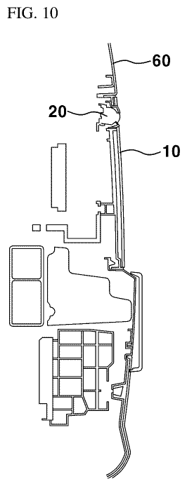

For example, as illustrated in FIGS. 6 and 9, a single module type sensor device 100 may be mounted at a central position in the width direction on the front surface portion of the vehicle (e.g., above a bumper cover). Alternatively, as illustrated in FIGS. 7 and 10, two module type sensor devices 100 may be mounted at predetermined positions on the left and right sides in the width direction on the front surface portion of the vehicle. Alternatively, as illustrated in FIG. 8 11, two module type sensor devices 100 may be mounted at predetermined positions on the left side in the width direction on the front surface portion of the vehicle.

Of course, a module type sensor device 100 may be mounted not only on the front surface portion of the vehicle but also on the side and rear surface portions of the vehicle.

Here, the plurality of clips 14 formed on the edge of the protector 10 may be inserted into and fastened to a vehicle body 60. The lower plate 31 or upper plate 32 of the bracket 30 may be mounted on the vehicle body 60, allowing the module type sensor device 100 to be firmly supported and fixed on the vehicle body 60.

As such, by allowing the module type sensor device, in which the camera, RADAR sensor, and LIDAR sensor for autonomous travelling of the vehicle are assembled into a single modular component, to be mounted at a desired location on the vehicle body, the sensor device for autonomous travelling may be commonly used in various types of vehicles, and the number of components and manufacturing costs may be reduced.

Here, the operation flow for sensor leveling of the module type sensor device for a vehicle according to the present disclosure is as follows.

In a case where changes in the vehicle body behavior occur when the RADAR sensor 51 and/or the LIDAR sensor 52 sense an adjacent vehicle, obstacle, and the like, the changes including changes in the left-right direction behavior of the vehicle body due to the vehicle's turning (e.g., rolling or yawing), changes in the front-rear direction behavior of the vehicle body due to sudden stopping or sudden starting (e.g., pitching) of the vehicle, and changes in the up-down direction behavior of the vehicle body due to changes in the number of passengers and the weight of load (e.g., carried by the vehicle), the sensing range or area of the RADAR sensor 51 and LIDAR sensor 52 must be automatically corrected so as to increase the sensing accuracy of the RADAR sensor 51 and/or the LIDAR sensor 52.

To this end, first, when a detection signal of a sensor configured to detect changes in vehicle body behavior (e.g., yaw rate sensor, lateral acceleration sensor, height sensor, etc.) is transmitted to a controller 70, the first motor 43 or the second motor 44 may be driven based on the control signal of the controller 70.

In response to the driving of the first motor 43, the first output gear 43-1 rotates in one (e.g., a first) direction or another (e.g., a second) direction, and the rotational force of the first output gear 43-1 is transmitted to the first sector gear 45 through the first pinion 47-1 and the second pinion 47-2 of the first transmission gear 47.

Thereafter, the first sector gear 45 rotates left or right, and at the same time, the tilting case 42 tilts to the left or right (e.g., relative to a horizontal axis) at a predetermined angle.

Here, because the first fastening protrusion 45-1 formed at the one (e.g., first) end portion of the first sector gear 45 is coupled to the first fastening hole 42-2 in the tilting case 42, when the first sector gear 45 rotates left or right, the tilting case 42 may also tilt left or right (e.g., relative to a horizontal axis) at a predetermined angle.

Moreover, sensor leveling in which the tilting case 42 tilts left or right at a predetermined angle, and at the same time, the sensor 50, i.e., the RADAR sensor 51 or the LIDAR sensor 52, also tilts at the same angle as the predetermined angle may be performed.

Here, because the second mounting wings 42-1 of the tilting case 42 are connected to the rear surface of the sensor 50, sensor leveling in which the sensor 50, i.e., the RADAR sensor 51 or the LIDAR sensor 52, tilts at the same angle as the tilting case 42 tilts left or right at a predetermined angle may be performed.

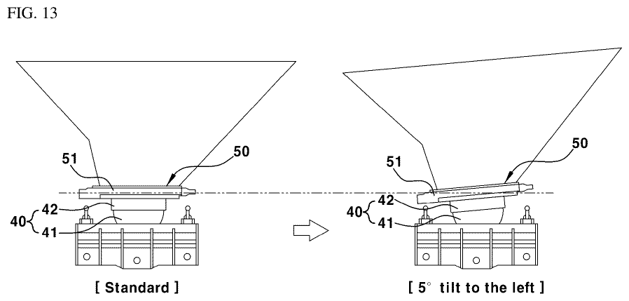

For example, the tilting case 42 and the sensor 50 may tilt about 5° to the right as illustrated in FIG. 12, or the tilting case 42 and the sensor 50 may tilt about 5° to the left as illustrated in FIG. 13. As used in this paragraph the term about may include the described angle (5°) and a range of plus or minus (±) 3° from the described angle.

Conversely, in response to the driving of the second motor 44, the second output gear 44-1 rotates in one (e.g., a first) direction or another (e.g., a second) direction, and the rotational force of the second output gear 44-1 is transmitted to the second sector gear 46 through the first pinion 48-1 and the second pinion 48-2 of the second transmission gear 48.

Thereafter, the second sector gear 46 rotates up or down, and at the same time, the tilting case 42 tilts up or down at a predetermined angle.

Here, because the second fastening protrusion 46-1 formed at the one end portion of the second sector gear 46 is coupled to the second fastening hole 42-3 in the tilting case 42, when the second sector gear 46 rotates up or down, the tilting case 42 may also tilt up or down (e.g., relative to the vertical axis) at a predetermined angle.

Moreover, sensor leveling in which the tilting case 42 tilts up or down at a predetermined angle, and at the same time, the sensor 50, i.e., the RADAR sensor 51 or the LIDAR sensor 52, also tilts at the same angle as the predetermined angle may be performed.

Here, because the second mounting wings 42-1 of the tilting case 42 are connected to the rear surface of the sensor 50, sensor leveling in which the sensor 50, i.e., the RADAR sensor 51 or the LIDAR sensor 52, tilts at the same angle as the tilting case 42 tilts up or down at a predetermined angle may be performed.

As such, when a change in the vehicle body behavior occurs, the sensing range or area of the sensor 50, such as the RADAR sensor 51 and the LIDAR sensor 52, may be automatically corrected by the sensor leveling performed by driving of the actuator 40, improving the sensing accuracy of the RADAR and LIDAR.

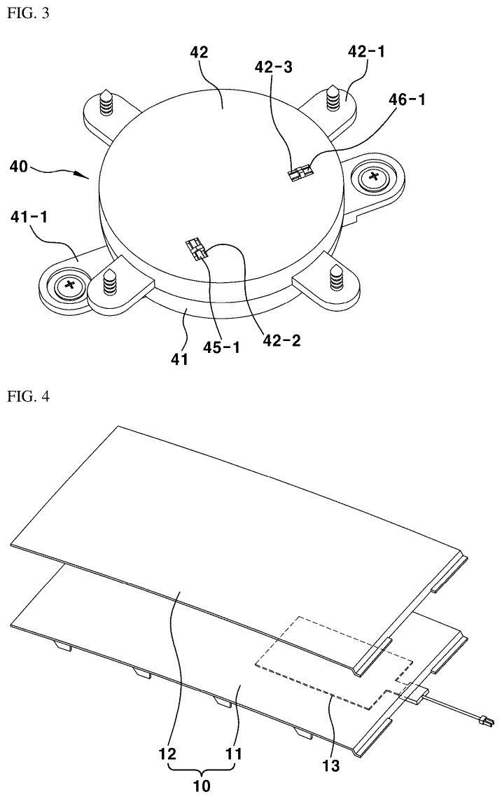

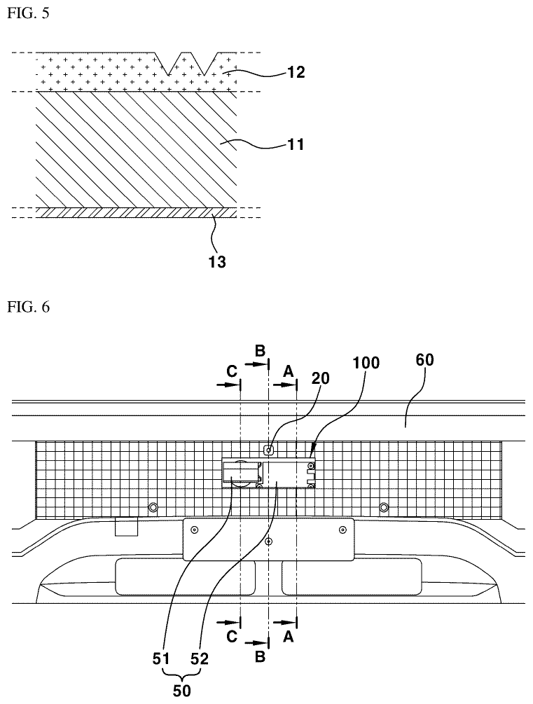

As illustrated in FIGS. 4 and 5, the protector 10 has a structure in which a base plate 11 injection-molded using or from a plastic material (e.g., polycarbonate (PC)), a protective cover 12 attached to an outer surface of the base plate 11, and a heat wire 13 attached to an inner surface of the base plate 11 are laminated.

Here, the protective cover 12 may be injection-molded using or from a polyurethane material having a hardness of 75 and a thickness of 0.4-1.0 millimeters.

As the material of the protective cover 12, hard polyurethane has high strength and is suitable for surface protection, but has a poor self-repairing performance or properties, and soft polyurethane has low strength and its use may cause or result in (e.g. more) severe surface damage to the extent where self-repairing is impossible. For this reason, as the material of the protective cover 12, polyurethane having a hardness of 75, which is between hard and soft, may be used.

To implement the self-repairing effect of the protective cover 12, the thickness of the protective cover 12 may be at least 0.4 millimeters. In a case where the thickness of the protective cover 12 exceeds 1.0 millimeter and is excessively thick, it may be disadvantageous in heat transfer from the heat wire 13 may be reduced, and thus, the self-repairing effect of the protective cover 12 may be reduced.

Accordingly, when the protective cover 12 of the protector 10 is damaged, for example, due to chipping or abrasion caused by stones, gravel, and the like, impacting the protective cover 12 during travelling or driving of the vehicle, a separate switch may be operated to supply current to the heat wire 13 to heat the heat wire 13. The heat resulting from the heating of the heat wire 13 is transferred to the protective cover 12, allowing self-healing in which the damaged area in the protective cover 12 is filled up. For example, the heat transferred from the heat wire 13 may melt a portion of the protective cover 12, a melted or liquid portion of the protective cover may then flow or move to a damaged portion of the protective cover, and the melted or liquid portion of protective layer may subsequently cool increasing a thickness of a damaged area of the protective cover 12.

As such, because the protector 10 has a laminated structure in which the protective cover 12 made of polyurethane material is attached to the outer surface of the base plate 11 made of plastic material, and the heat wire 13 configured to transfer heat to the protective cover 12 is attached to the inner surface of the base plate 11, when the protective cover 12 of the protector 10 is damaged due to chipping, abrasion, and the like, self-repairing in which the damaged area in the protective cover 12 is filled up by polyurethane material from an area of the protective cover surrounding the damaged area under the heat of the heat wire 13 may be performed, preventing malfunction of the sensor(s), for example, the RADAR sensor and/or LIDAR sensor or deterioration of sensing accuracy caused by damage to the protector.

As should be apparent from the above description, the present disclosure provides the following effects.

First, the camera, RADAR sensor, and LIDAR sensor for autonomous travelling or driving of the vehicle are modularized into a single unit and mounted at a desired location on the vehicle body, realizing common use in various types of vehicles and reduction in the number of components and manufacturing costs.

Second, in response to changes in behavior of the vehicle body, the sensing areas of the RADAR sensor and LIDAR sensor are automatically corrected using sensor leveling performed by driving the actuator, improving the sensing accuracy of the RADAR sensor and LIDAR sensor.

Third, because the protector has a laminated structure in which the protective cover made of polyurethane material is attached to the outer surface of the base plate, and the heat wire configured to transfer heat to the protective cover is attached to the inner surface of the base plate, when the protective cover of the protector is damaged due to chipping or abrasion, and the like, the damaged area in the protective cover may be self-repaired by the heating operation of the heat wire, preventing malfunction of the sensor(s) such as the RADAR sensor and/or LIDAR sensor and deterioration of sensing accuracy caused by damage to the protector.

Although the present disclosure has been described in detail with reference to several embodiments, the scope of the present disclosure is not limited to the above-described embodiments, and various modifications and improvements by those of ordinary skill in the art based on the basic concept of the present disclosure as defined in the claims below are also be included in the scope of the present disclosure.

What is claimed is:

1. A module type sensor device for a vehicle, the device comprising:
a protector mounted on a vehicle body;
a camera configured to capture images in front of the vehicle mounted on an upper portion of the protector;
a bracket mounted on a rear surface of the protector;
at least two actuators mounted on the bracket; and
at least two sensors, the at least two sensors coupled to respective ones of the at least two actuators and configured to tilt up and down or left and right by driving of respective ones of the at least two actuators.

2. The device of claim 1, wherein each of the at least two actuators comprise:
a fixed case mounted on the bracket;
a tilting case having a front surface portion coupled to a respective one of the at least two sensors and a rear surface portion tiltably brought into contact with the fixed case;
a first motor and a second motor mounted within the fixed case in a predetermined arrangement;
a first output gear and a second output gear, wherein the first output gear is connected to an output shaft of the first motor and the second output gear is connected to an output shaft of the second motor;
a first sector gear and a second sector gear each having one end portion connected to the tilting case; and
a first transmission gear and a second transmission gear mounted within the fixed case, wherein the first transmission gear is configured to transmit a rotational force of the first output gear to the first sector gear and the second transmission gear is configured to transmit a rotational force of the second output gear to the second sector gear.

3. The device of claim 2, wherein the first motor and the second motor are arranged perpendicular to each other within the fixed case, and the first output gear and the second output gear are also arranged perpendicular to each other.

4. The device of claim 2, wherein the first sector gear has an arch shape curved along a horizontal axis.

5. The device of claim 2, wherein a first fastening protrusion is formed on a first end portion of the first sector gear and a first fastening hole is formed in the tilting case, wherein the first fastening protrusion is inserted and fastened into the first fastening hole.

6. The device of claim 2, wherein the first transmission gear comprises a first pinion meshing with the first output gear, a second pinion meshing with the first sector gear, and a first rotational shaft configured to coaxially connect the first pinion to the second pinion and being rotatably coupled within the fixed case.

7. The device of claim 2, wherein the second sector gear has an arch shape curved along a vertical axis.

8. The device of claim 2, wherein a second fastening protrusion is formed on a first end portion of the second sector gear and a second fastening hole is formed in the tilting case, wherein the second fastening protrusion is inserted and fastened into the second fastening hole.

9. The device of claim 2, wherein the second transmission gear comprises a first pinion meshing with the second output gear, a second pinion meshing with the second sector gear, and a second rotational shaft configured to coaxially connect the first pinion to the second pinion and being rotatably coupled within the fixed case.

10. The device of claim 2, wherein first mounting wings are formed on a circumferential portion of the fixed case, and are mounted on a front surface portion of the bracket.

11. The device of claim 2, wherein second mounting wings are formed on a circumferential portion of the tilting case, and are mounted on a rear surface portion of the respective sensor of the at least two sensors.

12. The device of claim 1, wherein one of the at least two sensors is a radio detection and ranging (RADAR) sensor or a light imaging detection and ranging (LIDAR) sensor.

13. The device of claim 1, wherein the protector comprises:
a base plate made of plastic material;
a protective cover made of a polyurethane material, the protective cover attached to an outer surface of the base plate; and
a heat wire attached to an inner surface of the base plate.

14. The device of claim 13, wherein the protective cover is injection-molded with a polyurethane material having a hardness of 75 and a thickness in a range of 0.5-1.0 millimeters.

15. A module type sensor device for a vehicle, the device comprising:
a protecter mounted on a vehicle body;
a camera mounted on the protector;
a bracket mounted on a rear surface of the protector;
an actuator mounted on the bracket; and
a sensor coupled to the actuator and configured to tilt up and down or left and right by driving of the actuator.

16. The device of claim 15, wherein the actuator comprises:
a fixed case mounted on the bracket; and
a tilting case having a front surface portion coupled to the sensor and a rear surface portion movably brought into contact with the fixed case.

17. The device of claim 15, wherein the sensor is a radio detection and ranging (RADAR) sensor or a light imaging detection and ranging (LIDAR) sensor.

18. A module type sensor device for a vehicle, the device comprising:
a panel mounted on a vehicle body;
a camera mounted on the protector;
a bracket mounted on a rear surface of the protector;
a first actuator mounted on the bracket;
a first sensor coupled to the first actuator and configured to tilt up and down or left and right by driving of the first actuator;
a second actuator mounted on the bracket; and
a second sensor coupled to the first actuator and configured to tilt up and down or left and right by driving of the second actuator.

19. The device of claim 1, wherein the first actuator and the second actuator each include:
a fixed case coupled to the bracket; and
a tilting case movably coupled to the fixed case.

20. The device of claim 1, wherein the first sensor is a radio detection and ranging (RADAR) sensor and the second sensor is a light imaging detection and ranging (LIDAR) sensor.
